(19) United States
(12) Patent Application Publication
(10) Pub. No.: US 2020/0324800 A1
(43) Pub. Date: Oct. 15, 2020

(54) PAINT CART

(71) Applicant: Angel Gonzalez, Maitland, FL (US)

(72) Inventor: Angel Gonzalez, Maitland, FL (US)

(21) Appl. No.: 16/383,414

(22) Filed: Apr. 12, 2019

(51) Int. Cl. B62B 3/02; B62B 3/04

(52) U.S. Cl. CPC B62B 3/025; B62B 2501/065; B62B 2202/48; B62B 3/04

(57) ABSTRACT

A cart for storing painting materials is presented. The cart has a base for holding larger painting materials. The painting materials may be 5-gallon paint cans, one-gallon paint cans, etc. The cart has a plurality of wheels. The wheels are coupled to a bottom side of the base. A plurality of poles is coupled to the base and has pole inserts for coupling a plurality of shelves. The base may be twenty-two (22) inches in length from the pole in a first direction. The base may be ten (10) inches in length from the pole in a second direction. The cart may be forty (40) inches in height. The cart may be thirty (30) inches in length. The cart may be ten (10) inches in width. The cart is preferably made from high-density polyethylene (HDPE). The cart may have a top shelf, which is collapsible for storage when not in use. The base is collapsible when storing the cart.

### FIELD OF THE INVENTION

This invention relates to painting. More particularly, it relates to apparatus to carry painting tools and materials.

### BACKGROUND

A house painters and decorators are tradesman responsible for the painting and decorating of buildings, and is also known as a decorator or house painter. The purpose of painting is to improve the appearance of a building and to protect it from damage by water, corrosion, insects and mold.

Historically, the painter was responsible for the mixing of the paint; keeping a ready supply of pigments, oils, thinners and driers. The painter would use his experience to determine a suitable mixture depending on the nature of the job. In modern times, the painter is primarily responsible for preparation of the surface to be painted, such as patching holes in drywall, using masking tape and other protection on surfaces not to be painted, applying the paint and then cleaning up.

Larger firms operating within the trade were generally capable of performing many painting or decoration services, from creating an accent wall to sign writing, to the gilding of objects or the finishing or refinishing of furniture.

More recently, professional painters are responsible for all preparation prior to painting. All scraping, sanding, wallpaper removal, caulking, drywall or wood repair, patching, stain removal, filling nail holes or any defects with plaster or putty, cleaning, taping, preparation and priming are considered to be done by the professional contracted painter.

One of the main issues for painters and decorators is that they must bring each item necessary when painting in separately and store them separately. Therefore, there is a need for an apparatus to hold the items and the paint a painter or decorator desires and needs when performing their job.

### BRIEF DESCRIPTION OF THE DRAWINGS

FIG. 1 is an illustrated view of an exemplary cart.

FIG. 2 is an illustrated front view of the exemplary cart in FIG. 1 with a 5-Gallon hook shown.

FIG. 3 is an illustrated side view of the exemplary cart shown in FIG. 1 with folding base.

FIG. 4 is an illustrated left-side view of the exemplary cart shown in FIG. 1.

FIG. 5 is an illustrated right-side view of the exemplary cart shown in FIG. 1.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

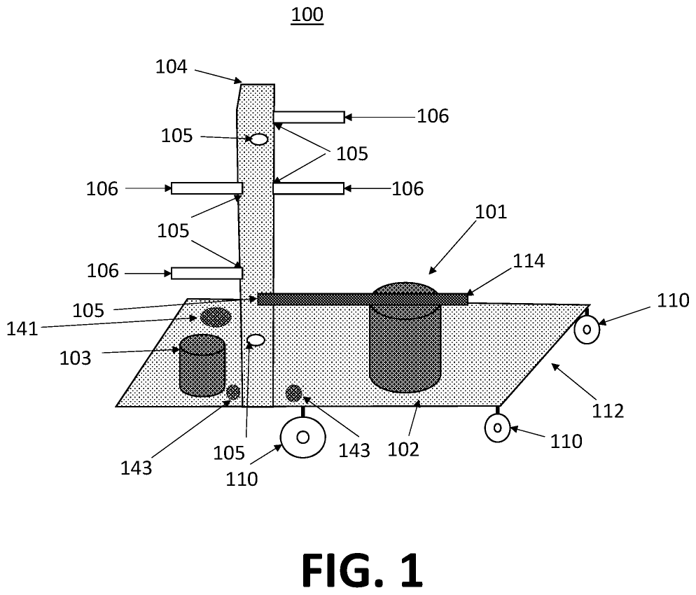

Referring to FIG. 1, an illustrated view of a cart 100 for carrying painting supplies is presented. The cart 100 is useful for storing painting supplies and efficiently moving the painting supplies to a desire location.

The cart 100 is preferably forty (40) inches in height, but may be other heights as desired. The cart 100 is preferably thirty (30) inches in length, but may be any length desired. The cart 100 is preferably twenty-four (24) inches in width, but may be any width desired. The cart 100 is preferably made of High-Density Polyethylene (HDPE), but may be made of other materials such as steel, plastic, PVC, fiberglass, etc.

The cart 100 has a base 102, a plurality of poles 104 and a plurality of shelves 106. The bottom shelf 102 is preferably twenty-two (22) inches in length but may be other lengths as desired.

The poles 104 are coupled to the base 102. The base 102 extends twenty-two (22) inches on a first side 108 of the poles 104 but may be other lengths as desired. The base 102 preferably extends ten (10) inches on a second side 110 of the poles 104 but may be other lengths as desired. The base 102 is preferably twenty (20) inches in width but may be other widths as desired.

The base 102 has a plurality of wheels 110. The plurality of wheels 110 are coupled to a bottom 112 of the base 102. The wheels 110 are useful for easily moving the painting supplies from one location to a desired location. The base 102 is useful for storing larger items such as five-gallon paint cans 101, one-gallon paint cans 103, etc.

The poles 104 have one or more pole insert 105. The one or more pole inserts 105 are useful for adding shelves, hooks, hangers, etc. to store additional painting materials.

The plurality of shelves 106 are coupled to the poles 104 at the pole inserts 105. The plurality of shelves 106 are useful for hold painting materials such as roller tray, primer, stirrers, pouring spouts, roller covers, painting tape, paint brushes, painter rollers, drop clothes, paint thinner, etc. The shelves 106 may have one or more 1-gallon paint holders 141, 5-gallon paint holders 142, and one or more utensil holders 143. The 5-gallon paint can 101 is placed in the 5-gallon paint holder 142 to secure the large paint can 101 to prevent spillage.

The cart 100 further has a handle 114. The handle 114 is coupled to the poles 104 preferably near the base 102, but may be located anywhere on the poles 104. The handle 114 is useful for steering and controlling the movement of the cart 100 when the cart 100 in mobile.

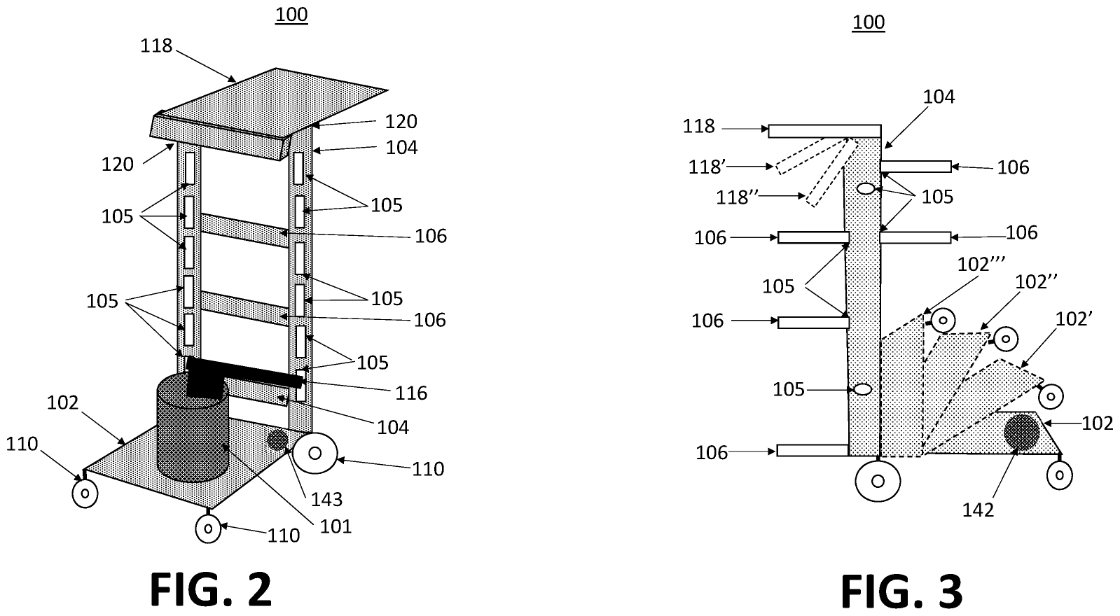

An illustrated front view of the exemplary cart 100 of FIG. 1 is shown in FIG. 2.

The cart 100 has a base 102, a plurality of poles 104, a top shelf 118 and a plurality of shelves 106. The bottom shelf 102 is preferably twenty-two (22) inches in length but may be other lengths as desired.

The poles 104 are coupled to the base 102. The base 102 extends twenty-two (22) inches on a first side 108 of the poles 104 but may be other lengths as desired. The base 102 preferably extends ten (10) inches on a second side 110 of the poles 104 but may be other lengths as desired. The base 102 is preferably twenty (20) inches in width but may be other widths as desired. The top shelf 118 is coupled to the pole inserts 105 at substantially a top end 120 of the poles 104.

The base 102 has a plurality of wheels 110. The plurality of wheels 110 are coupled to a bottom 112 of the base 102. The wheels 110 are useful for easily moving the painting supplies from one location to a desired location. The base 102 is useful for storing larger items such as five-gallon paint cans 101, one-gallon paint cans 103, etc.

The poles 104 have one or more pole insert 105. The one or more pole inserts 105 are useful for adding shelves, hooks, hangers, etc. to store additional painting materials.

The plurality of shelves 106 are coupled to the poles 104 at the pole inserts 105. The plurality of shelves 106 are useful for hold painting materials such as roller tray, primer, stirrers, pouring spouts, roller covers, painting tape, paint brushes, painter rollers, drop clothes, paint thinner, etc.

The cart 100 has a paint bucket hook 116. The paint bucket hook 116 is useful for stabilizing the 5-gallon paint can 101 when the cart 100 is in motion or when the 5-gallon paint can 101 is in use. The paint bucket hook 116 is coupled to the pole inserts 105 and extends into the 5-gallon paint can 101. The one or more 1-gallon paint holders 142 are further placed on one of the shelves 106.

FIG. 3 is an illustrated view of the exemplary cart 100 of FIG. 1 with folding shelves is shown.

The cart 100 has a base 102, a plurality of poles 104, a top shelf 118 and a plurality of shelves 106. The bottom shelf 102 is preferably twenty-two (22) inches in length but may be other lengths as desired.

The poles 104 are coupled to the base 102. The base 102 extends twenty-two (22) inches on a first side 108 of the poles 104 but may be other lengths as desired. The base 102 preferably extends ten (10) inches on a second side 110 of the poles 104 but may be other lengths as desired. The base 102 is preferably twenty (20) inches in width but may be other widths as desired.

The top shelf 118 is hingedly coupled by a hinge 122 to the pole inserts 105 at substantially a top end 120 of the poles 104. The top shelf 118 is foldable such that it can either be collapsed to store the top shelf 118 or to extend the top shelf 118 to have additional storage space. The top shelf 118 is shown being collapsed. The top shelf 118 is moved to a second position 118′ by engaging the hinge 122 in a downward direction. The top shelf 118′ is moved to a third position 118″ to store the top shelf 118″ against the poles 104.

The base 102 is hingedly coupled to a bottom end 124 of the posts 104 by a second hinge. The base 102 is foldable such that it can either be placed in a position to store painting materials or to fold the base 102 for storing. The base 10 is initially shown in a first position to store painting materials. The base 102 is moved to a second position 102′ by engaging the hinge 122 in an upward direction. The base 102′ is moved to a third position 102″. The base 102″ is moved to a fourth position 102′″ to store the base 102′″ against the poles 104 by moving the base 102″ in an upward direction.

The base 102 has a plurality of wheels 110. The plurality of wheels 110 are coupled to a bottom 112 of the base 102. The wheels 110 are useful for easily moving the painting supplies from one location to a desired location. The base 102 is useful for storing larger items such as five-gallon paint cans 101, one-gallon paint cans 103, etc.

The poles 104 have one or more pole insert 105. The one or more pole inserts 105 are useful for adding shelves, hooks, hangers, etc. to store additional painting materials.

The plurality of shelves 106 are coupled to the poles 104 at the pole inserts 105. The plurality of shelves 106 are useful for hold painting materials such as roller tray, primer, stirrers, pouring spouts, roller covers, painting tape, paint brushes, painter rollers, drop clothes, paint thinner, etc.

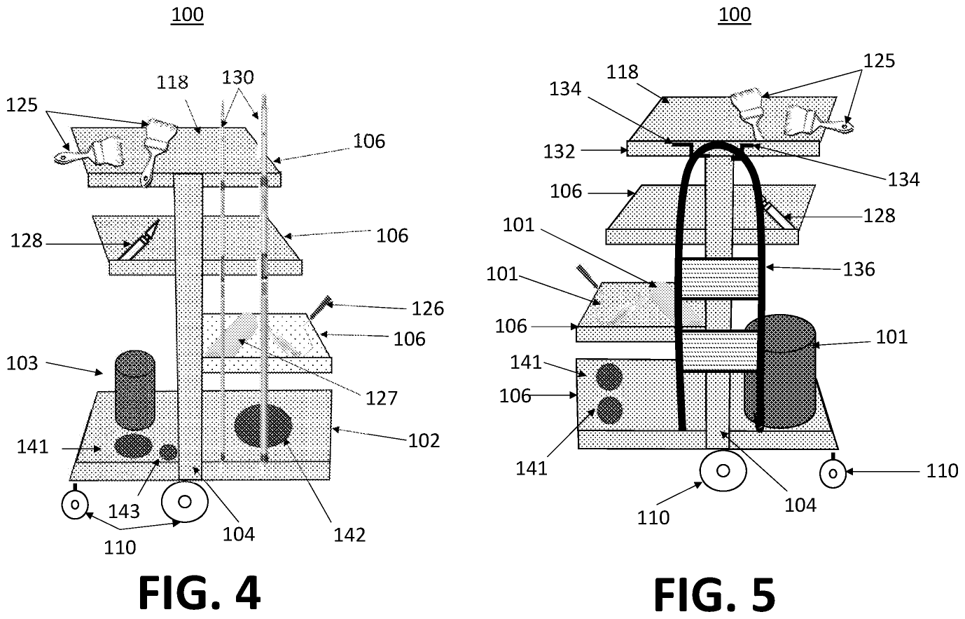

Describing FIG. 4, a left side view of the exemplary cart 100 of FIG. 1 is shown.

The cart 100 has a base 102, a plurality of poles 104, a top shelf 118 and a plurality of shelves 106. The bottom shelf 102 is preferably twenty-two (22) inches in length but may be other lengths as desired.

The poles 104 are coupled to the base 102. The base 102 extends twenty-two (22) inches on a first side 108 of the poles 104 but may be other lengths as desired. The base 102 preferably extends ten (10) inches on a second side 110 of the poles 104 but may be other lengths as desired. The base 102 is preferably twenty (20) inches in width but may be other widths as desired.

The top shelf 118 is coupled to the pole inserts 105 at substantially a top end 120 of the poles 104. The top shelf 118 has two paint brushes 125 stored on it.

The base 102 has a plurality of wheels 110. The plurality of wheels 110 are coupled to a bottom 112 of the base 102. The wheels 110 are useful for easily moving the painting supplies from one location to a desired location. The base 102 is useful for storing larger items such as five-gallon paint cans 101, one-gallon paint cans, etc.

The poles 104 have one or more pole insert 105. The one or more pole inserts 105 are useful for adding shelves, hooks, hangers, etc. to store additional painting materials.

The plurality of shelves 106 are coupled to the poles 104 at the pole inserts 105. The plurality of shelves 106 are useful for hold painting materials such as roller tray, primer, stirrers, pouring spouts, roller covers 127, painting tape, paint brushes, painter rollers 126, drop clothes, paint thinner, paint edger 128, etc. Two paint roller extenders 130 are coupled to the base 102 and the top shelf 118. The coupling may be a hook, a connector, etc.

Describing FIG. 5, a right-side view of the exemplary cart 100 of FIG. 1 is shown.

The cart 100 has a base 102, a plurality of poles 104, a top shelf 118 and a plurality of shelves 106. The bottom shelf 102 is preferably twenty-two (22) inches in length but may be other lengths as desired.

The poles 104 are coupled to the base 102. The base 102 extends twenty-two (22) inches on a first side 108 of the poles 104 but may be other lengths as desired. The base 102 preferably extends ten (10) inches on a second side 110 of the poles 104 but may be other lengths as desired. The base 102 is preferably twenty (20) inches in width but may be other widths as desired.

The top shelf 118 is coupled to the pole inserts 105 at substantially a top end 120 of the poles 104. The top shelf 118 has two paint brushes 125 stored on it.

The base 102 has a plurality of wheels 110. The plurality of wheels 110 are coupled to a bottom 112 of the base 102. The wheels 110 are useful for easily moving the painting supplies from one location to a desired location. The base 102 is useful for storing larger items such as five-gallon paint cans 101, one-gallon paint cans, etc.

The poles 104 have one or more pole inserts 105. The one or more pole inserts 105 are useful for adding shelves, hooks, hangers, etc. to store additional painting materials.

The plurality of shelves 106 are coupled to the poles 104 at the pole inserts 105. The plurality of shelves 106 are useful for hold painting materials such as roller tray, primer, stirrers, pouring spouts, roller covers 127, painting tape, paint brushes, painter rollers 126, drop clothes, paint thinner, paint edger 128, etc.

A ladder 136 are coupled to a side 132 of the top shelf 118. The top shelf 118 has two s-hooks 134 coupled to the side 132 of the top shelf 118. The ladder 136 is coupled to the two s-hooks 134 to secure the ladder 136 for transport.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A cart for storing painting materials, the cart comprising:
a base, the base for holding larger painting materials;
a plurality of wheels, the wheels for moving the cart, wherein the plurality of wheels being coupled to a bottom side of the base;
a plurality of poles, the pole coupled to base, wherein the poles having pole inserts; and
a plurality of shelves, the shelves for storing painting materials, wherein the plurality of shelves coupled to the pole inserts of the poles.

2. The cart of claim 1, wherein the base being hingedly coupled to the poles.

3. The cart of claim 2, wherein the base being foldable.

4. The cart of claim 1, further comprising:
a top shelf, the top shelf being coupled to a top side of the poles.

5. The cart of claim 4, wherein the top shelf being hingedly coupled to the poles.

6. The cart of claim 5, wherein the top shelf being foldable.

7. The cart of claim 1, wherein the cart being made of a high-density polyethylene (HDPE) material.

8. The cart of claim 1, wherein the cart having a height of forty (40) inches.

9. The cart of claim 1, wherein the cart having a length of thirty (30) inches.

10. The cart of claim 1, wherein the cart having a width of twenty-four (24) inches.

11. The cart of claim 1, wherein the painting materials being a 5-gallon paint can.

12. The cart of claim 1, further comprising:
An s-hook, the s-hook being coupled to a first side of the poles.

13. The cart of claim 12, wherein a ladder being coupled to the s-hook of the first side of the poles.

14. The cart of claim 1, wherein the larger items being one-gallon paint cans.

15. The cart of claim 1, wherein the base extends twenty-two (22) inches in a first direction from the poles.

16. The cart of claim 1, wherein the base extends ten (10) inches in a second direction from the poles.

17. The cart of claim 1, wherein the cart being movable.

18. The cart of claim 1, wherein a paint hook being coupled to the poles for stabilizing a 5-gallon paint can when the cart being in transport.
